(19) United States
(12) Patent Application Publication
(10) Pub. No.: US 2014/0073502 A1
(43) Pub. Date: Mar. 13, 2014

(54) ENHANCED SEED TREATMENTS USING OILS

(71) Applicants: Charles Jones, Greensboro, NC (US); Carolyn Moore, Greensboro, NC (US); Andrew Pearson, Greensboro, NC (US)

(72) Inventors: Charles Jones, Greensboro, NC (US); Carolyn Moore, Greensboro, NC (US); Andrew Pearson, Greensboro, NC (US)

(73) Assignee: SYNGENTA PARTICIPATIONS AG, Basel (CH)

(21) Appl. No.: 14/004,577

(22) PCT Filed: Mar. 9, 2012
(86) PCT No.: PCT/US2012/028520

§ 371 Date: Nov. 19, 2013

Related U.S. Application Data
(60) Provisional application No. 61/451,854, filed on Mar. 11, 2011.

(51) Int. Cl. A01N 25/02; A01N 43/56

(52) U.S. Cl. CPC A01N 25/02; A01N 43/56
USPC 504/100; 514/783; 514/784; 514/785; 514/406

(57) ABSTRACT

A stabilized oil-in-water seed treatment formulation having superior handling characteristics.

### TECHNICAL FIELD

The present invention relates to seed treatments, and in particular seed treatments that improve seed coating coverage, storage stability, seed flowability and reduced dust-off.

### BACKGROUND

The use of pesticides to control pests in crops is a wide spread practice. This practice has gained a high degree of commercial success because it has been shown that such control can increase crop yield. Pesticides can be applied directly to plant propagation materials (such as seeds) prior to sowing and/or are used in foliar or furrow applications.

A seed treatment is any material applied to a seed. Examples of seed treatments include, inter alia, pesticides, non-pesticide formularies, and mixtures thereof. Non-pesticide formularies generally include material such as surfactants, humectants, fillers, and polymers that influence the treated seed characteristics. Seed treatments are generally used on a large variety of crops to control a large variety of pests. Seed treatments are commonly used to ensure uniform stand establishment by protecting against soil borne diseases and insects. Systemic seed treatments may provide an alternative to traditional broadcast sprays of foliar fungicides or insecticides for certain early season airborne diseases and insects.

Pesticide seed treatments come in a variety of formulations: dry flowables (DF), liquid flowables (LF), true liquids (TL), emulsifiable concentrates (EC), dusts (D), wettable powders (WP), suspoemulsions (SE), water-dispersible granules (WG) and others. Some are registered for use only by commercial applicators using closed application systems; others are readily available for on-farm use as dusts, slurries, water soluble bags, or liquid ready-to-apply formulations.

Commercial seed treatment often requires specialized equipment to properly apply treatments or to treat large volumes of seed. An important concern of the commercial treater is equipment performance to ensure the delivery of a proper amount of active ingredient to the seed. This has become especially important with more modern fungicides that require only small amounts of material.

Conveniently, many seed treatment materials also are available for on-farm use. These are known as hopper-box or planter-box treatments wherein liquid or dry formulations are applied to seed as it passes through an auger from the transport bin or truck to the planter boxes. These formulations are a very convenient way to apply seed treatment onto bulk seed right before planting. Conventional dry treatments generally are formulated with talc or graphite which adheres the treatment chemical to the seed. Conventional liquid hopper-box treatments generally are made available as fast-drying formulations. In any case, good seed coverage is required for maximum benefit from any seed treatment formulation.

However, obtaining thorough seed coverage can be difficult when attempting to treat seed. For example, dry formulations can present unacceptable worker exposure to the fungicidal or insecticidal active ingredient. Problems can arise such as unacceptable drying times, material build-up in the seed treater, low seed flowability, poor seed coverage and dust-off of the pesticide from the seed prior to planting. As a result, handling is rendered difficult and the biological efficacy of the seed treatment may be reduced.

Seed coating additives are seed treatments used to remedy problems such as low seed flowability and excessive dust-off. However, it is well known that selection of a seed coating additive to reduce dust-off will likely have the adverse effect of decreasing seed flowability. Likewise, it is well known that selection of a seed coating to increase seed flowability will likely have the adverse effect of increasing dust-off

Accordingly, there is a need in the art for a seed treatment that provides more uniform coating coverage, increases seed flowability and decreases dust-off.

### SUMMARY

It has now been discovered, surprisingly, that specific seed treatment compositions have improved coating coverage, improved flowability and improved adherence to plant propagation material with low or no dust-off. The compositions of the invention have particular application in the protection of plant propagation materials, such as seeds, against pests when combined with one or more pesticides.

The present technology thus provides an improved seed treatment suitable for applying plant propagation materials. The seed treatment of the present technology includes the use of an oil or oils in seed treatment formulations. The inclusion of oil has been found to have advantageous properties associated with the seed treatment including: uniformity of the treatment on the seed, reduced crystallization in the formulation, improved storage stability of the formulation, increased flowability and plantability of the treated seeds, and increased adherence of the formulation to the seed.

The present technology also provides for improved treatment efficiency and working conditions through the increased adherence of the formulation to the seed. Increased adherence to the seed will result in a reduction of dust-off. A reduction in dust-off results in cleaner seed treatment machinery, which reduces downtime in the necessity of cleaning the machinery. A reduction in dust-off also results in improved working conditions for workers. The present technology also provides for a reduction in seed treatment residue build-up in the treatment machinery. Residue from seed treatment product results in unwanted build-up and contamination (e.g. differing seed treatments and/or doses) in the seed treatment machinery.

### DETAILED DESCRIPTION

The inventors have found that the use of oils in seed treatment formulations yields the surprising result of a seed treatment that improves uniformity of the treatment on the seed, reduced crystallization in the formulation, improved storage stability of the formulation, increased flowability and plantability of the treated seeds, and increased adherence of the formulation to the seed.

Seed treatment formulations of the present technology applied to a seeds generally comprise an oil, one or more pesticides, a surfactant or surfactants, polymers, inert carriers, antifreeze agents, and other formulary additives. The seed treatment formulations provide compositions that are storage stable and are suitable for use in normal seed treatment equipment, such as a slurry seed treater, direct treater, panogen treater or a mist-o-matic treater as well as on-farm hopper-box or planter-box treatments. Propagation materials treated with the compositions of the present technology dry quickly, have good flowability, suitable coverage and have little or no dust-off. The compositions are advantageously combined with a pesticidally effective amount of at least one pesticide.

### Oils

The term “oil” or “oils” as used herein include a fatty acid, fatty acids, an ester of a fatty acid or esters of fatty acids. Preferred oils are generally esters of C₆-C₂₁ fatty acids. Preferred fatty acids include oleic acid, linoleic acid (e.g. alpha-linoleic acid), palmitic acid, stearic acid, arachidic acid, lauric acid, myristic acid, and linolenic acid.

In one embodiment the oils are triglycerides, such as natural oils. The term “natural oil” or “natural oils” as used herein is an oil or oils whose chemical structure has not been modified by a chemical reaction. Preferred examples of natural oils include oils such as canola oil, linseed oil, soybean oil, corn oil, safflower oil, palm oil, sunflower oil, peanut oil, cottonseed oil, palm kernel, and olive oil. Others can also include tung oil and castor oil.

Compositions created using the present technology include oil. The compositions generally contain from about 5% to about 35% by weight of the composition of oil. In other embodiments, the compositions generally contain from about 5% to about 25% by weight of the composition of oil, 5% to about 20% by weight of the composition of oil, 5% to about 15% by weight of the composition of oil, 5% to about 10% by weight of the composition of oil, and 10% to about 20% by weight of the composition of oil.

### Pesticides

The term “pesticide” as used herein is intended to cover compounds active against pests which are intended to repel, kill, or control any species designated a pest including weeds, insects, rodents, fungi, bacteria, or other organisms.

Examples of suitable individual compounds of the above mentioned compound classes are listed below. Where known, the common name is used to designate the individual compounds (q.v. the Pesticide Manual, 12th edition, 2001, British Crop Protection Council).

Examples of pesticides include those selected from, for example and not for limitation, insecticides, acaricides, bactericides, fungicides, nematicides and molluscicides.

Suitable additions of insecticidally, acaricidally, nematicidally, or molluscicidally active ingredients are, for example and not for limitation, representatives of the following classes of active ingredients: organophosphorus compounds, nitrophenols and derivatives, formamidines, triazine derivatives, nitroenamine derivatives, nitro- and cyanoguanidine derivatives, ureas, benzoylureas, carbamates, pyrethroids, chlorinated hydrocarbons and Bacillus thuringiensis products. Especially preferred components in mixtures are abamectin, cyanoimine, acetamiprid, thiodicarb, nitromethylene, nitenpyram, clothianidin, dinotefuran, fipronil, lufenuron, pyripfoxyfen, thiacloprid, fluxofenime; imidacloprid, thiamethoxam, chlorantraniliprole, cyantraniliprole, beta cyfluthrin, lambda cyhalothrin, fenoxycarb, diafenthiuron, pymetrozine, diazinon, disulphoton; profenofos, furathiocarb, cyromazin, cypermethrin, tau-fluvalinate, tefluthrin or Bacillus thuringiensis products, very especially abamectin, thiodicarb, cyanoimine, acetamiprid, nitromethylene, nitenpyram, clothianidin, dinotefuran, fipronil, thiacloprid, imidacloprid, thiamethoxam, sulfloxaflor, chloranthraniliprole, beta cyfluthrin, lambda cyhalothrin, and tefluthrin.

Suitable additions of fungicidally active ingredients are, for example and not for limitation, representatives of the following classes of active ingredients: strobilurins, triazoles, ortho-cyclopropyl-carboxanilide derivatives, phenylpyrroles, and systemic fungicides. Examples of suitable additions of fungicidally active ingredients include, but are not limited to, the following compounds: sedaxane, azoxystrobin; bitertanol; carboxin; Cu₂O; cymoxanil; cyproconazole; cyprodinil; dichlofluamid; difenoconazole; diniconazole; epoxiconazole; fenpiclonil; fludioxonil; fluoxastrobin, fluquiconazole; flusilazole; flutriafol; furalaxyl; guazatin; hexaconazole; hymexazol; imazalil; imibenconazole; ipconazole; kresoxim-methyl; mancozeb; metalaxyl; mefenoxam; metconazole; myclobutanil, oxadixyl, pefurazoate; penconazole; pencycuron; prochloraz; propiconazole; pyroquilone; (±)-cis-1-(4-chlorophenyl)-2-(1H-1,2,4-triazol-1-yl)cycloheptanol; spiroxamin; tebuconazole; thiabendazole; tolifluamide; triazoxide; triadimefon; triadimenol; trifloxystrobin, triflumizole; triticonazole and uniconazole. Particularly preferred fungicidally active agents include sedaxane, azoxystrobin, difenoconazole, fludioxonil, thiabendazole, tebuconazole, metalaxyl, mefenoxam, myclobutanil, fluoxastrobin, tritaxonazole, and trifloxystrobin.

In certain embodiments mixtures are the fungicide combinations disclosed below:

TABLE 1

| | | | |
|---|---|---|---|
| Sedaxane | Mefanoxam | | |
| Sedaxane | Difenoconazole | | |
| Sedaxane | Fludioxonil | | |
| Sedaxane | Azoxystrobin | | |
| Sedaxane | Azoxystrobin | Mefanoxam | |
| Sedaxane | Azoxystrobin | Difenoconazole | |
| Sedaxane | Azoxystrobin | Fludioxonil | |
| Sedaxane | Mefanoxam | Difenoconazole | |
| Sedaxane | Mefanoxam | Fludioxonil | |
| Sedaxane | Mefanoxam | Difenoconazole | Fludioxonil |
| Sedaxane | Mefanoxam | Difenoconazole | Azoxystrobin |
| Sedaxane | Mefanoxam | Fludioxonil | Azoxystrobin |

Further contemplated are the individual fungicide combinations disclosed in Table 1, further combined with a neonicitoid insecticide, specifically thiamethoxam, clothianidin, or imidicloprid.

Further contemplated are the individual fungicide combinations disclosed in Table 1, further combined with the insecticide chlorantraniliprole and/or cyantraniliprole.

In one embodiment, the pesticidally active compound or compound mixture is present in the composition in an amount of from about 0.5% to about 50% by weight, more specifically, from 2 to about 30% by weight of the entire composition.

In one embodiment, compositions of the present technology include at least one water insoluble pesticide and at least one water soluble pesticide. As defined herein, a water soluble pesticide is one with a solubility of 500 parts per million (ppm) or greater. As defined herein, a water insoluble pesticide is one with a solubility of less than 500 ppm.

### Surfactants

Seed treatment compositions may also contain at least about 2% up to about 15% by weight of a surfactant.

Generally the surface-active agent may comprise one or more nonionic surfactant and may optionally further comprise one or more anionic surfactants.

Exemplary nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, and mono- and diesters of ethylene glycol and mixtures thereof.

Specific examples of suitable nonionic surfactants include: Genapol X-060 (Clariant) (ethoxylated fatty alcohol); Sorpohor BSU (Rhodia) ethoxylated tristyrylphenol; Makon TD-6 (Stepan) (ethoxylated fatty alcohol); BRIJ 30 (Uniqema) (ethoxylated lauryl alcohol); Witconol CO-360 (Witco) (ethoxylated castor oil); and Witconol NP-60 (Witco) (ethoxylated nonylphenol). Suitable nonionic surfactants can be prepared by methods known per se and also are commercially available.

In general, the anionic surfactant may be any known in the art. Suitable anionic surfactants are in general oligomers and polymers, as well as polycondensates, which contain a sufficient number of anionic groups to ensure their water-solubility. Suitable anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols , mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Specific examples of suitable anionic surfactants include: Geropon T77 (Rhodia) (N-methyl-N-oleoyltaurate Na salt); Soprophor 4D384 (Rhodia) (tristyrylphenol sulphate); Reax 825 (Westvaco) (ethoxylated lignin sulfonate); Stepfac 8171 (Stepan) (ethoxylated nonylphenol phosphate ester); Ninate 401-A (Stepan) (calcium alkylbenzene sulfonate); Emphos CS-131 (Witco) (ethoxylated nonylphenol phosphate ester); Ufoxane 3A, NA (sodium lignosulphonate); Morwet D425 (sodium alkylnapthalenesulfonate), Reax 1425E (lignin sulfonate ethoxylate), and Atphos 3226 (Uniqema) (ethoxylated tridecylalcohol phosphate ester). Suitable anionic surfactants can be prepared by methods known per se and also are commercially available.

In addition to anionic and nonionic surfactants, certain cationic or zwitterionic surfactants may also be suitable for use in the present invention such as alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-₁₈ fatty amine polyalkoxylates.

Mixtures of surfactants (a1), (a2) and optionally (a3) may be employed as follows: (1) 0.5-4% by weight of a wetting agent selected from (a1) at least one anionic surfactant. Suitable anionic surfactant wetting agents include sulfoalkylamides and salts thereof such as N-methyl-N-oleoyltaurate Na salt, alkylaryl sulfonates such as alkylbenzene sulfonates and alkylnaphthalene sulfonates and salts thereof and salts of ligninsulfonic acid; (2) 1-4% by weight of a dispersing agent selected from (a1) at least one anionic surfactant. Suitable anionic surfactant dispersing agents include sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts; (3) 1 to 5% by weight of an emulsifying agent selected from (a1) at least one anionic surfactant, (a2) at least one nonionic surfactant and a mixture thereof. Suitable anionic/nonionic surfactant emulsifiers include salts of ethoxylated alkylphenols, polyoxyethylene-polyoxypropylene alkylphenols, (fatty) alcohol ethoxylates and ethoxylated tristyrylphenols.

The aqueous composition may also include at least one polymer selected from water-soluble and water-dispersible film-forming polymers. Suitable polymers have an average molecular weight of at least about 1,000 up to about 100,000; more specifically at least about 5,000, up to about 100,000. The aqueous compositions generally contain from about 0.5% to about 10% by weight of the composition of polymer (b). In a specific embodiment, the compositions contain from about 1.0% up to about 5% by weight of a film-forming polymer (b).

Suitable polymers are selected from

b1) alkyleneoxide random and block copolymers such as ethylene oxide-propylene oxide block copolymers (EO/PO block copolymers) including both EO-PO-EO and PO-EO-PO block copolymers;

ethylene oxide-butylene oxide random and block copolymers,

C₂₋₆ alkyl adducts of ethylene oxide-propylene oxide random and block copolymers,

C₂₋₆ alkyl adducts of ethylene oxide-butylene oxide random and block copolymers,

b2) polyoxyethylene-polyoxypropylene monoalkylethers such as methyl ether, ethyl ether, propyl ether, butyl ether or mixtures thereof.

b3) vinylacetate/vinylpyrrolidone copolymers,

b4) alkylated vinylpyrrolidone copolymers,

b5) polyvinylpyrrolidone, and

b6) polyalkyleneglycol including the polypropylene glycols and polyethylene glycols.

Specific examples of suitable polymers include Pluronic P103 (BASF) (EO-PO-EO block copolymer), Pluronic P65 (BASF) (EO-PO-EO block copolymer), Pluronic P108 (BASF) (EO-PO-EO block copolymer), Vinamul 18160 (National Starch) (polyvinylacetate), Agrimer 30 (ISP) (polyvinylpyrrolidone), Agrimer VA7w (ISP) (vinyl acetate/vinylpyrrolidone copolymer), Agrimer AL 10 (ISP) (alkylated vinylpyrrolidone copolymer), PEG 400 (Uniqema) (polyethylene glycol), Pluronic R 25R2 (BASF) (PO-EO-PO block copolymer), Pluronic R 31R1 (BASF) (PO-EO-PO block copolymer) and Witconol NS 500LQ (Witco) (butanol PO-EO copolymer).

In one embodiment of the technology, the surfactant is of the formula R¹—O-(AO)ₓ—(H), where R¹ is a straight-chain or branched alkyl having 2 to 30 carbon atoms; preferably 2 to 10 carbon atoms; AO is ethyleneoxy, propyleneoxy, or a mixture of ethyleneoxy and propyleneoxy; and x is from 40 to 120. Preferably x is greater that than 40 and preferably from 50 to 80.

The aqueous composition may also comprise, at least about 4 and up to about 20%, more specifically from 5 to about 15% of at least one inorganic solid carrier.

The inorganic solid carrier is a natural or synthetic solid material that is insoluble in water. This carrier is generally inert and acceptable in agriculture, especially on the treated seed or other propagation material. It can be chosen, for example, from clay, diatomaceous earth, natural or synthetic silicates, titanium dioxide, magnesium silicate, aluminum silicate, talc, pyrophyllite clay, silica, attapulgite clay, kieselguhr, chalk, lime, calcium carbonate, bentonite clay, Fuller's earth, and the like such as described in the CFR 180.1001. (c) & (d).

Seed treatment compositions may also contain at least about 5% up to about 25% by weight of an antifreeze agent.

Specific examples of suitable antifreezes include ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol and the like.

As a particular subset of suitable antifreeze materials there can be mentioned ethylene glycol, propylene glycol and glycerol (glycerine).

### Additional Components

The composition may also contain (e) at least one thickener.

In one embodiment, the thickener is present in the aqueous composition in an amount from about 0.01% to about 25% w/w, more specifically from 0.02 to 10% by weight of the entire composition.

Illustrative of thickeners (water-soluble polymers which exhibit pseudoplastic properties in an aqueous medium) are gum arabic, gum karaya, gum tragacanth, guar gum, locust bean gum, xanthan gum, carrageenan, alginate salt, casein, dextran, pectin, agar, 2-hydroxyethyl starch, 2-aminoethyl starch, 2-hydroxyethyl cellulose, methyl cellulose, carboxymethyl cellulose salt, cellulose sulfate salt, polyacrylamide, alkali metal salts of the maleic anhydride copolymers, alkali metal salts of poly(meth)acrylate, and the like.

As suitable thickeners there may also be mentioned attapulgite-type clay, carrageenan, croscarmellose sodium , furcelleran , glycerol, hydroxypropyl methylcellulose, polystyrene, vinylpyrrolidone/styrene block copolymer, hydroxypropyl cellulose, hydroxypropyl guar gum, and sodium carboxymethylcellulose.

The composition according to the invention can be employed together with the adjuvants customary in formulation technology, biocides, biostats, emulsifiers (lethicin, sorbitan, and the like), antifoam agents or application-promoting adjuvants customarily employed in the art of formulation. In addition, there may be mentioned inoculants and brighteners.

Additionally, a coloring agent, such as a dye or pigment (and the like such as described in the CFR 180.1001) is included in the seed coating so that an observer can immediately determine that the seeds are treated. The dye is also useful to indicate to the user the degree of uniformity of the coating applied.

The inventive compositions contain and/or may be applied together or sequentially with further active compounds. These further compounds can be fertilizers or micronutrient donors or other preparations that influence plant growth. They can also be selective herbicides, insecticides, fungicides, bactericides, insect growth regulators, plant growth regulators, nematicides, molluscicides or mixtures of several of these preparations.

The pesticidal compositions of the invention can be prepared by processes known in the art.

In one embodiment, the compositions of the invention can be prepared by a process which comprises the steps: (a) forming a premix with at least one pesticidal compound, at least one surfactant, oil and water (b) forming a premix of a thickener and water, and (c) sequentially adding the premixes (a) and (b) and the remaining ingredients to water while stirring to form a homogeneous composition.

In one aspect, solid pesticidally active compounds may be wet milled prior to being added to the mixture.

The final composition can be screened if desired to remove any insoluble particles.

Plant propagation material, as defined herein, encompasses both true seeds and plant propagation material. While plant propagation material encompasses true seeds, plant propagation material itself is commonly referred to as a seed and is defined as such herein. Most seed treatments are applied to true seeds, which have a seed coat surrounding an embryo. Seed treatments are also applied to plant propagation materials such as rhizomes, bulbs, corms or tubers.

In general, the amount of fungicide, insecticide or other ingredients used in the seed treatment are employed in amounts that do not inhibit germination of the seed or cause phytotoxic damage to the seed. The total amount of active ingredients is generally in the range of from about 0.5% to about 50% by weight, more specifically, from 2 to about 20% by weight of the composition.

Suitable target seeds are seeds where a seed treatment would be deemed advantageous, especially common are those of maize, potatoes, cereals (e.g. wheat, barley, rye, oats, rice), sugar beet, cotton, millet varieties such as sorghum, sunflowers, beans, peas, oil plants such as canola, rape, soybeans, cabbages, tomatoes, eggplants (aubergines), pepper and other vegetables and spices as well as ornamental shrubs and flowers. Suitable target seeds also include those of transgenic crop plants of the aforementioned varieties.

The techniques of seed treatment application are well known to those skilled in the art, and they may be used readily in the context of the present invention. The compositions of the invention are applied to the seed as slurry, soak, or drip. There also may be mentioned, e.g., film coating or encapsulation. The coating processes are well known in the art, and employ, for seeds, the techniques of film coating or encapsulation, or for the other multiplication products, the techniques of immersion. Needless to say, the method of application of the inventive compositions to the seed may be varied and the invention is intended to include any technique that is to be used.

One method of applying the compositions according to the present technology consists in spraying or wetting the plant propagation material with a liquid preparation, or mixing the plant material with such liquid preparation.

As noted above, the compositions of this invention may be formulated or mixed in the seed treater tank or combined on the seed by overcoating with other seed treating agents. The agents to be mixed with the compounds of this invention may be for the control of pests, nutrition, and the control of plant diseases.

The inventive pesticidal composition has particular application to concurrent (such as by slurry) and sequential seed treatments.

The pesticidal compositions of the invention are both cold and heat stable and can be applied to seeds at temperatures ranging from −20 to 40° C.

A principal feature of the inventive composition is that it provides for a treated seed with increased adherence which results in decreased dustiness and the subsequent elimination of related dust problems. Elimination of the dust associated with many seed treatments also eliminates the associated health hazards to those who work with treated seeds, such as processing plant employees, truck drivers, warehouse workers, and farmers.

Another principle feature of the inventive composition is that it provides for a treated seed with increased flowability that that prevents against seed bridging. Seed bridging generally occurs during the removal of seeds from hopper-type storage. During storage treated seeds may have a tendency to stick together and during removal from storage the seeds at the bottom of the hopper storage will create a void while the top seeds create the bridge over the void. To continue removing the seeds the bridge must be broken. Because of the large size of hopper storage, or unfamiliarity with the danger of doing so, breaking the bridge is sometimes facilitated by a person climbing into the hopper and manually breaking the bridge. This act is very dangerous; a person may fall through the bridge and directly into the removal equipment (e.g. auger or conveyer belt) and/or being suffocated by seeds which have now fallen upon breaking of the bridge.

Still another advantage of the technology is the uniform coating of-seeds with non-dusting seed treatment which will not interfere with germination and sprouting of the seed but which will protect the seed against seed-borne pathogens.

### Comparative Examples Measuring Dust-Off

For each of the following tests 50 grams of Lillian Spring Wheat was placed in a Heubach Dust Meter for five minutes. The tests includes an (1) untreated check, (2) a commercially available seed treatment (Dividend® XL RTA from Syngenta Crop Protection, a fungicide seed treatment containing no oil), and (3) a seed treatment composition in accordance with the present technology. In each treated test, the slurry volume of the seed treatment was 325 ml/100 kg seed. Measured dust-off amounts are shown in Table 1 below.

TABLE 1

| Untreated Check | Dividend XL RTA | Present Technology |
|---|---|---|
| 0.52 mg | 1.72 mg | 0.07 mg |

For each of the following tests 50 grams of AC Metcalfe Barley was placed in a Heubach Dust Meter for five minutes. The tests includes an untreated check, a commercially available seed treatment (Dividend® XL RTA from Syngenta Crop Protection, a fungicide seed treatment containing no oil), and a seed treatment composition in accordance with the present technology. In each treated test, the slurry volume of the seed treatment was 325 ml/100 kg seed. Measured dust-off amounts are shown in Table 2 below.

TABLE 2

| Untreated Check | Dividend XL RTA | Present Technology |
|---|---|---|
| 0.61 mg | 2.15 mg | 0.39 mg |

It is apparent from the above data that seeds treated with the inventive composition have superior handling characteristics than the seeds treated with the comparative compositions. The above data highlights the surprising efficacy of the composition of Example 54.

Although the foregoing invention has been described in some detail by way of illustration and example for purposes of clarity of understanding, it will be apparent that various changes and modifications may be practiced within the scope of the appended claims.

We claim:

1. A stabilized oil-in-water formulation for applying to a seed comprising by weight %:
5-35% unmodified natural oil;
0.5-50% active ingredient;
2.5-15% surfactant;
5-25% antifreeze agent; and
20-50% water.

2. The formulation of claim 1, where said unmodified natural oil is selected from oleic acid; canola oil, linseed oil, soybean oil, corn oil, safflower oil, palm oil, sunflower oil, peanut oil, cottonseed oil, palm kernel, and olive oil.

3. The formulation of claim 1, wherein said active ingredient is sedaxane.

4. A method for improving the seed handling characteristics of a plant seed, the method comprising:
applying a stabilized oil-in-water formulation to a plant seed, wherein said stabilized oil-in-water formulation comprises:
5-35% unmodified natural oil;
0.5-50% active ingredient;
2.5-15% surfactant;
5-25% antifreeze agent; and
20-50% water.

5. A stabilized oil-in-water formulation comprising by weight %:
(a) 5-35% unmodified natural oil;
(b) 0.5-50% water soluble pesticidally active ingredient;
(c) 0.5-50% water insoluble pesticidally active ingredient;
(d) 2.5-15% at least one surfactant of the formula I
R¹—O-(AO)ₓ—(H) (I)
wherein
R¹ is a straight-chain or branched alkyl having 2 to 30 carbon atoms;
AO is ethyleneoxy, propyleneoxy, or a mixture of ethyleneoxy and propyleneoxy; and
x is from 40 to 80.
(e) 5-25% antifreeze agent; and
(f) 20-50% water.

6. An article of manufacture comprising:
a plant seed treated with an oil-in-water formulation comprising:
5-35% oil;
0.5-50% pesticidally active ingredient;
2.5-15% surfactant;
5-25% antifreeze agent; and
20-50% water.
